(19) United States
(12) Patent Application Publication
(10) Pub. No.: US 2017/0318281 A1
(43) Pub. Date: Nov. 2, 2017

(54) DEVICE FOR VIEWING STEREOSCOPIC 3D IMAGES

(71) Applicant: MOBILE VR SWEDEN AB, Sundsval (SE)

(72) Inventors: Joakim EDLUND, Sundsvall (SE); Daniel SANDVIK, Bromma (SE)

(73) Assignee: MOBILE VR SWEDEN AB, Sundsval (SE)

(21) Appl. No.: 15/531,249

(22) PCT Filed: Nov. 25, 2015
(86) PCT No.: PCT/SE2015/051265

§ 371 Date: May 26, 2017

(30) Foreign Application Priority Data
Nov. 27, 2014 (SE) 1451446-7

(51) Int. Cl. H04N 13/04; F16M 13/04; G02B 27/22

(52) U.S. Cl. CPC H04N 13/044; H04N 13/0497; F16M 13/04; G02B 27/225; H04N 2213/001

(57) ABSTRACT

A device for viewing stereoscopic 3D images using an electronic device with a screen display includes: a head fastener; a holder to receive and removably accommodate the electronic device in an accommodation space; a lens focusing light from the screen display to the eyes of the user; and a distance part, providing a predetermined distance between the lens and the screen display. The lens part provides a first image from a first part of the screen display to a first eye of the user, and a second image from a second part of the screen display to a second eye of the user. The holder part is supported relative to the lens by the distance part, the distance part being arranged to be reversibly collapsible, from a fully expanded state, in which the lens part is arranged at said predetermined distance from the screen display, to a contracted state.

The present invention relates to a device for viewing stereoscopic 3D images. In particular, the invention relates to such a device which is itself not capable of producing such stereoscopic 3D images, but into which an electronic device comprising a screen display can be inserted, after which a pair of different images displayed simultaneously on the said screen display are focussed by the device to a respective eye of a user of the device. In particular, the present invention relates to such a device which can be fastened to the head of a user for display of said different images directly to the respective eye of the user.

Head-mounted devices for showing stereoscopic 3D images are known in general. For instance, Sony Morpheus® and Oculus Rift® are head-mounted display devices featuring one respective screen display for displaying a respective image to each eye of a user on the head of which the device is mounted. By varying the images to reflect what would actually be seen by each respective individual eye in a certain situation, a “submersive” 3D viewing experience is achieved for the user. Such devices may also comprise posture sensors arranged to read the posture of the user's head, so that the viewed images can be adapted in reaction to the current viewing angle of the device.

Devices are also known that make use of an existing electronic device with a screen display, such as a conventional smartphone, to achieve a similar effect. In such devices, the electronic device is fastened to a structure which in turn is fastened to the user's head and arranged to focus a respective one of a pair of images displayed on the device's screen display to a respective eye of the user. The device's built-in posture sensors can be used to determine the device viewing direction, and for updating the said displayed pair of 3D experience providing images. Examples of such devises comprise the ones described in ES1115455 and WO2011119459, and as brought to the market under the names DuroVis Dive®, VrAse®, HasBro® My3D®, Samsung® Gear VR®, Google® Cardboard® and AlterGaze®. Pinć® is another solution which has recently been presented.

Since such devices themselves do not have to comprise any electronic functionality for displaying images, which functionality is provided by the electronic device, they can be simple and therefore inexpensive, while still providing a realistic submersive 3D user experience.

However, there are a number of problems with existing such devices.

One problem is that they are often of quite bulky and complicated design, and are primarily intended for being used in a stationary manner or after certain preparation. It would be desirable to provide an easy-to-use, lightweight and portable device at a low production cost, which is still sturdy enough to be useful when out and about without breaking or otherwise deteriorate.

In addition thereto, there is a need for interacting with the viewed 3D image content. Such interaction is provided via the above described posture sensors. However, it would be desirable to be able to, for instance, select what type of 3D images to view without having to remove the electronic device from its position in front of the user's eyes.

The present invention solves these problems.

Hence, the present invention relates to a device for viewing stereoscopic 3D images using an electronic device comprising a screen display, which device comprises a head fastening means, arranged to fasten the device to a user's head so that the device assumes a mounted position on said head; a holder part arranged to receive and removably accommodate the electronic device in an accommodation space; a lens part arranged to focus light from said screen display to the eyes of the user when the device is in said mounted position and the electronic device is arranged in said accommodation space; as well as a distance part, arranged to provide a predetermined distance between the lens part and the screen display, wherein the lens part is arranged to, when the device is in said mounted position, provide a first image from a first part of the screen display to a first eye of the user, and a second image from a second part of the screen display to a second eye of the user, which first and second parts are distinct from each other, and is characterised in that the holder part is supported in relation to the lens part by the distance part, in that the distance part is arranged to be reversibly collapsible along a collapsing direction, which collapsing direction extends between the holder part and the lens part, from a fully expanded state, in which the lens part is arranged at said predetermined distance from the screen display, to a contracted state, in which the lens part is arranged closer to the holder part than what is the case in said fully expanded state, and in that the outer dimensions of the device decrease as a result of such collapse.

In the following, the invention will be described in detail, with reference to exemplifying embodiments of the invention and to the enclosed drawings, in which:

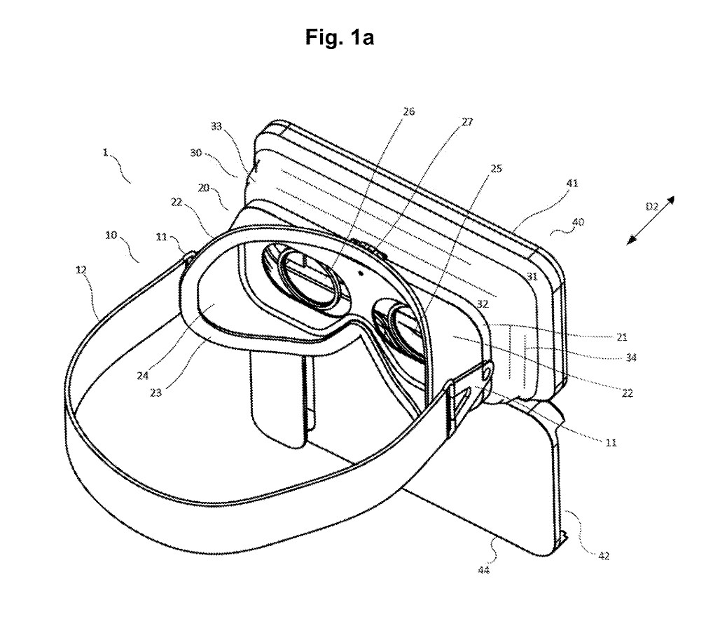

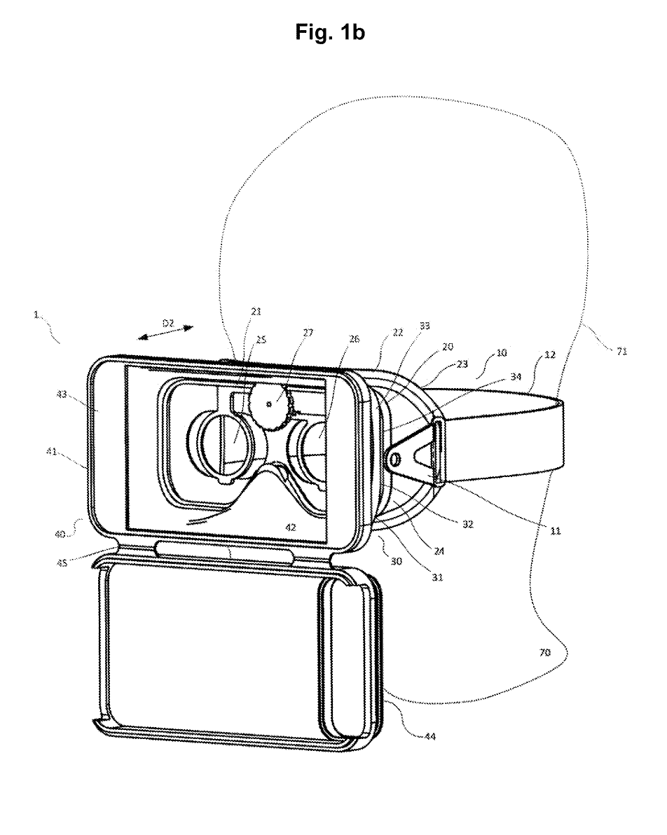

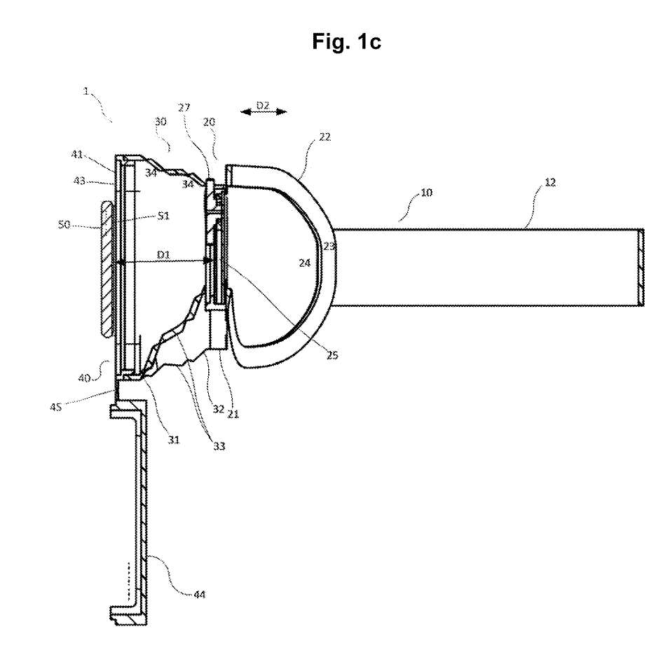

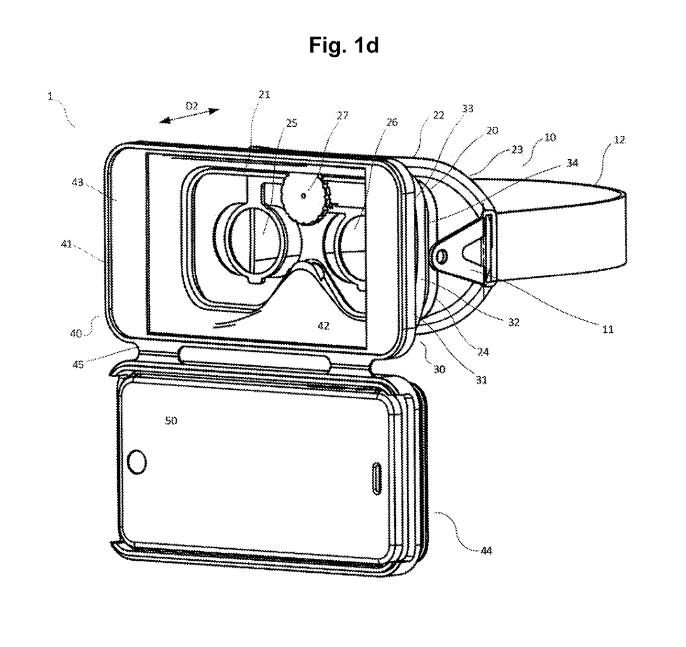

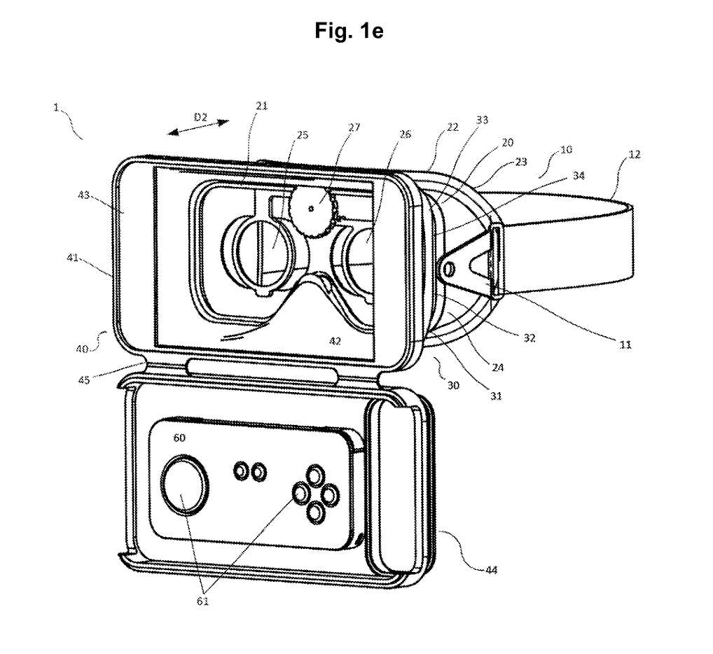

FIG. 1a is a perspective view of a device according to the present invention with an opened lid and as seen from its back;

FIG. 1b is a perspective view of the said device with an opened lid and as seen from its front, and also the head of a user (coarsely illustrated) on which the device is mounted;

FIG. 1c is a side cross-sectional view of the said device with an opened lid;

FIGS. 1d and 1e are the same as FIG. 1b, but not showing the user and instead showing an electronic device and a remote control, respectively, located inside an accommodation space of the said device;

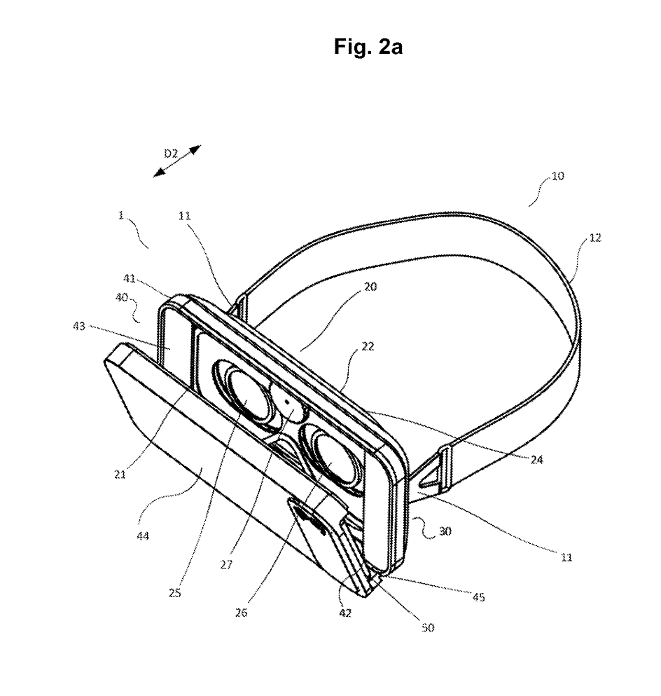

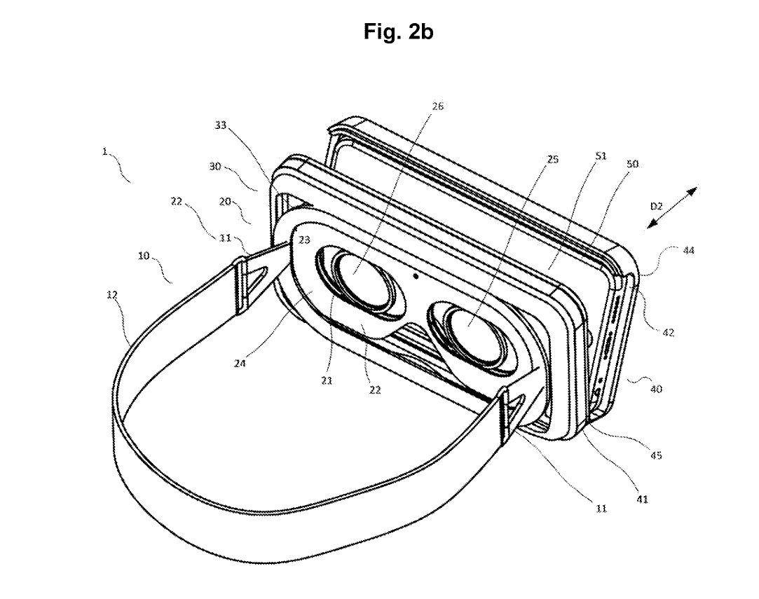

FIG. 2a is a perspective view from the front of the said device with a partly closed lid and in a folded together state;

FIG. 2b is a perspective view from the back of the said device with a partly closed lid and in the said folded together state;

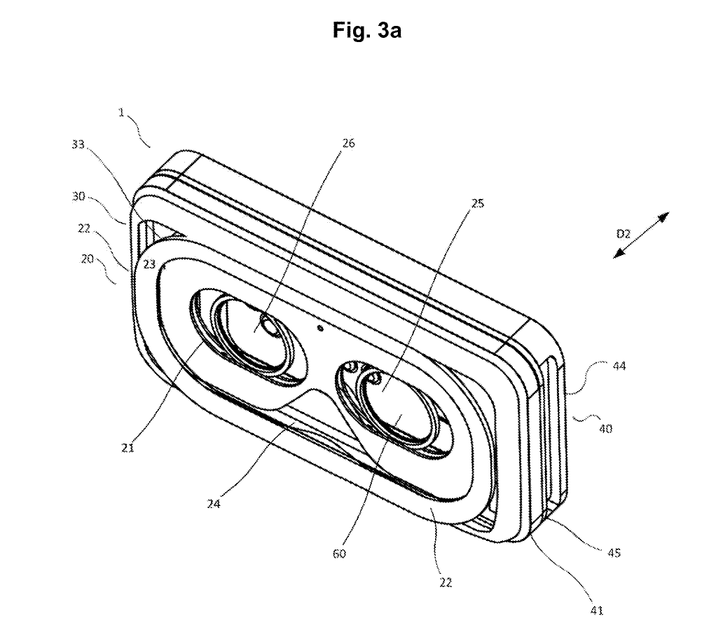

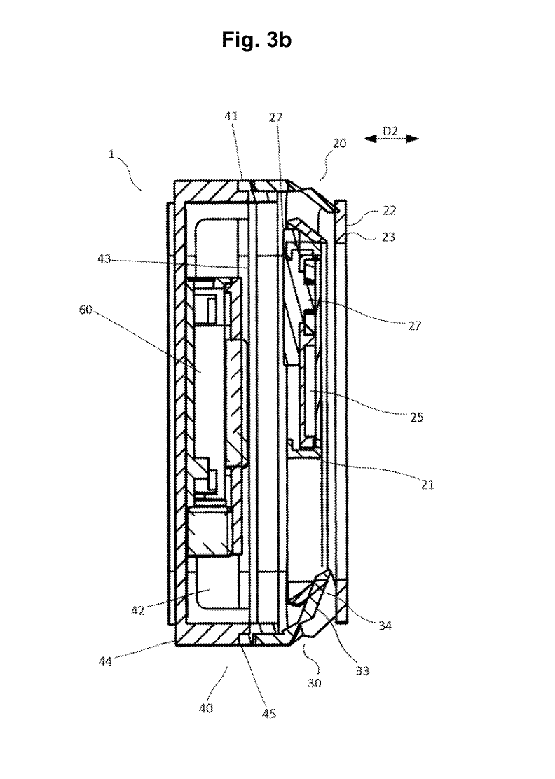

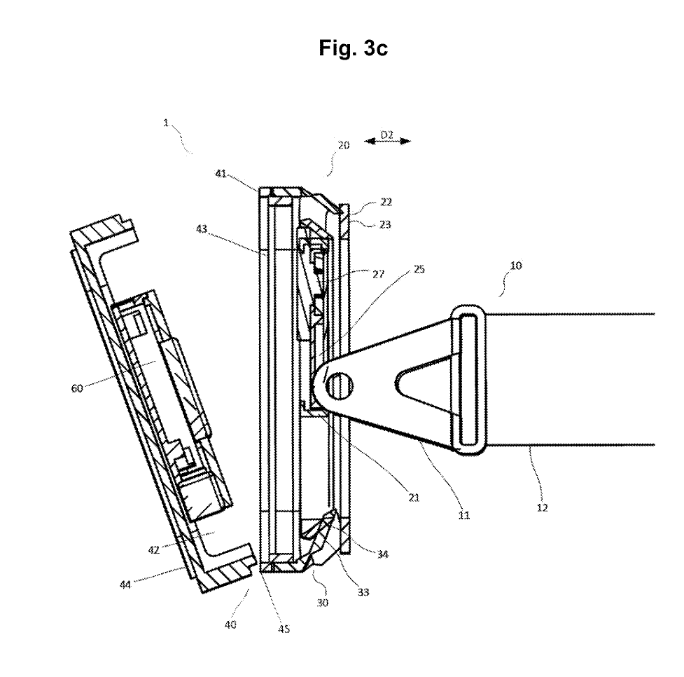

FIG. 3a is a perspective view from the back of the said device, not showing a fastening part of the device but accommodating a remote control in an accommodation space thereof, which device has a completely closed lid and is in the said folded together state;

FIG. 3b is a side cross-sectional view of the said device as shown in FIG. 3a;

FIG. 3c is the same as FIG. 3b, but with a partly closed lid and showing the said fastening means;

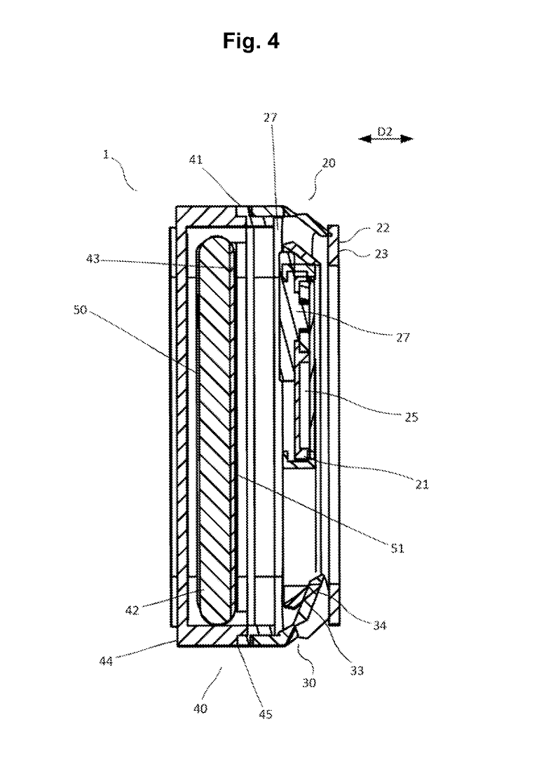

FIG. 4 is the same as FIG. 3b, but in which the device accommodates an electronic device rather than a remote control in said accommodation space;

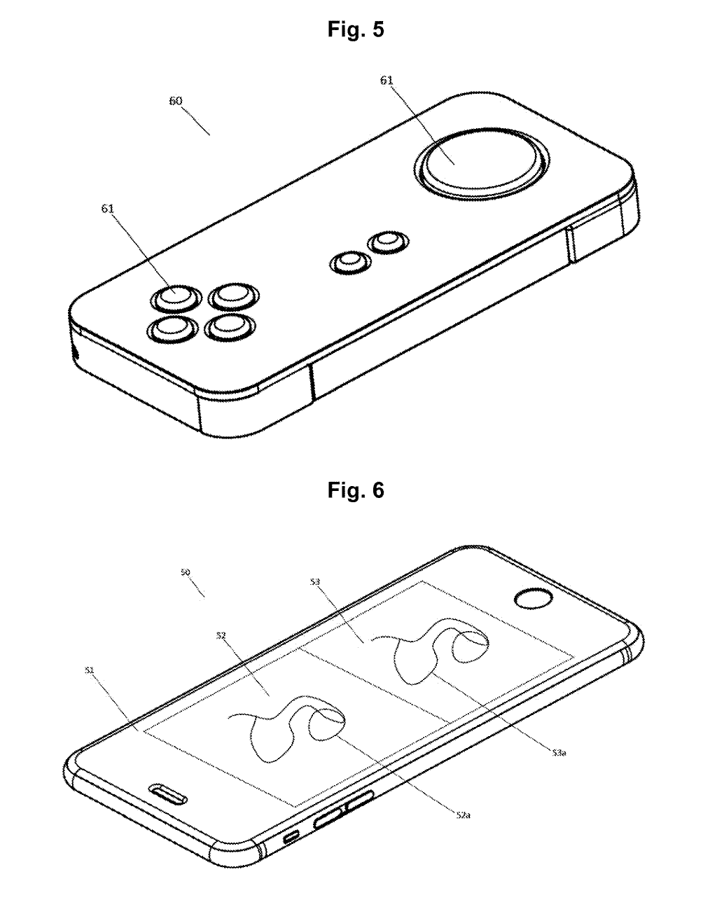

FIG. 5 is a perspective view of a remote control; and

FIG. 6 is a perspective view of an electronic device.

All figures show one and the same exemplifying device according to the invention is various positions, and all figures share reference numerals for the same parts.

Hence, the figures illustrate a device 1 according to the present invention for viewing stereoscopic 3D images using a portable electronic device 50 which in turn comprises a screen display 51. It is noted that the electronic device 50 is not a part of the device 1.

The portable electronic device 50 may be of any suitable type, as long as it fits inside the accommodation space 42 of the holder part 40 (see below), and as long as it comprises a screen display 51 capable of displaying a pair of images 52a, 53a simultaneously (see FIG. 6), for displaying to a respective eye each of a user 70 of the device 1 (see below). Preferably, the electronic device 50 is roughly cuboidic in shape, and has a generally flat shape where the screen display 51 preferably covers the majority of one of its two large sides. The screen display 51 is preferably between about 8 and about 16 cm diagonally across, and is preferably a raster image type screen display comprising at least 500×1000 screen pixels. Such electronic devices are today frequently used in the form of conventional mobile phones of so called “smartphone” type; media players, such as the iPod® and similar; etc. It is particularly preferred that the device 1 is specifically adapted to receive and accommodate such a portable electronic device 50 of standard type, and even more preferably an electronic device 50 selected from a possible range of such electronic devices having slightly different shapes and dimensions, but with a respective screen display arranged in roughly the same location in relation to the basic shape of the electronic device in question. Preferably, the accommodation space 42 is adapted to hold such electronic devices 50 that are between 100 and 200 mm long; between 50 and 100 mm wide; and between 5 and 15 mm thick.

According to the invention, the device 1 comprises a head fastening means 10, arranged to fasten the device 1 to a user's 70 head 71 (see FIG. 1b), so that the device 1 assumes a mounted position on said head 71. This position is illustrated in FIG. 1b, in which however the lid 44 is opened; when viewing 3D images, the lid 44 would be completely closed, holding the electronic device 50 in the accommodation space as is illustrated in FIG. 4.

Preferably, in the said mounted position, the device 1 is mounted on the head 71 so that it covers the eyes of the user 70 completely, and so that it extends more or less horizontally out from the face of the user 70 when the user 70 keeps his or her head 71 in a normal upright vertical position.

In order not to be too difficult to wear during prolonged usage, it is desired that the device 1 weighs at the most 200 g, more preferably at the most 100 g, not counting the weight of the electronic device 50 or the remote control 60 (see below). The design proposed by the present invention makes such a lightweight construction possible while still offering a versatile, comfortable and sturdy product.

The head fastening means 10 comprises a strap part 12, which is preferably elastic and preferably adjustable with respect to its length. The strap part 12 is fastened to the device 11 using fastening means 11 such as ears, in turn fastened to the device 1, in a way which is similar to the construction of conventional scuba diving masks. Specifically, it is preferred that the fastening means 11 are fastened to the lens part 20, so that the respective fastening point of each fastening means 11 is fixed in relation to a rigid part or frame 21 of the lens part 20 (see below). This provides for full comfort yet good operating conditions for a flexible light shield part 24 of the lens part 20.

Furthermore, the device 1 comprises a holder part 40, arranged to receive and removably accommodate the electronic device 50 in an accommodation space 42 comprised in the holder part 40. The accommodation is fixed in the sense that the position of the electronic device 50 while accommodated in the accommodation space 42 cannot easily be altered from a predetermined position in which the location of the screen 50 in relation to the lens part 20 is such that the displayed images 52a, 52b are clearly visible to the respective eyes of the user 70. It is preferred that lightweight compressible foam means (not shown in the figures) are arranged in the holder part 40, that are compressed when an electronic device 50 is inserted in the accommodation space 42, thereby keeping the electronic device 50 in the said predetermined position. Such holding/positioning means cooperate with a shoulder 43 of the holder part 40.

The device 1 also comprises a lens part 20, arranged to focus light from the screen display 51 of the electronic device 50, accommodated in the accommodation space 42 with its screen 51 arranged towards the lens part 20, to the eyes of the user 70 when the device 1 is in said mounted position with its lid 44 completely closed.

Also, the device 1 comprises a distance part 30, arranged to provide a predetermined distance D1 (see FIG. 1c) between the lens part 20 and the screen display 51, more particularly between a particular plane of the lens part 20, such as a focal plane of the lens part 30, and the surface of the screen display 51. The lens part 30 preferably comprises at least one, preferably two distinct, lenses 24, 25. In the case with two lenses 24, 25, it is preferred that each respective lens 24, 25 is arranged to direct a respective different image 52a, 53a displayed on the screen display 51 to a respective eye of the user 70 each, so as to achieve a stereoscopic viewing effect. It is preferred that the predetermined distance D1 is between the screen display 51 and the lenses 24, 25, and that the predetermined distance D1 in this case is between 30 and 60 mm, preferably about 40 mm, most preferably 42±1 mm. Moreover, the lenses 24, 25 are preferably aspherical.

It is furthermore preferred that the light from the screen display 51 is directed directly towards the eyes of the user 70, passing only through the respective lens 24, 25 on its way. It would also be possible to use mirrors, prisms and/or additional lenses to reflect and/or refract the light in additional ways, which would allow for more complicated shapes of the device 1. However, it is preferred that the light from the screen display 51 passes nothing but a respective lens 24, 25, preferably only a single such respective lens 24, 25, on its way from the screen display 51 to the respective eye of the user 70. This provides a simple yet useful design.

When the device 1 is in the said mounted position (FIG. 1b but with lid 44 completely closed), the lens part 20 is arranged to provide a first image 52a from a first part 52 of the screen display 51 to a first eye of the user 70, and a second image 53a from a second part 53 of the screen display 51 to a second eye of the user 70 (see FIG. 6). The first 52 and second parts 53 are distinct from each other on the screen display 51, meaning that they are non-overlapping on the screen display 51, preferably being displayed as two respective rectangles of predetermined shape, size and position, one displayed beside the other on the screen 51.

It is preferred that the distance part 30 is arranged to be reversibly collapsible, from a fully expanded state (FIG. 1c) in which the lens part 20 is arranged at the said predetermined distance D1 from the holder part 40, to a contracted state (FIG. 4, which however does not show the fastening part 10) in which the lens part 20 is arranged closer to the holder part 40 than what is the case in the said fully expanded state. From this contracted state, the distance part 30 can again be expanded up to the fully expanded state, so that the distance between the lens part 20 and the holder part 40 is again the said predetermined distance D1. The distance part 30 is arranged so that it locks in the fully expanded state, such as reversibly snaps into a fully expanded position, in which state/position the predetermined distance D1 is substantially fixed and can only be affected by reshaping of the distance part 30 by using certain force once the distance part 30 has been fully expanded.

Such locking may, for instance, be accomplished using a latch mechanism using which a rigid distance element is attached between the lens part 20 and the holder part 40. However, it is preferred, as is illustrated in the figures and described below, that the distance part 30 is self-supporting and has an expandable shape which is relatively stable and well-defined in the fully expanded state.

The collapsing and expansion is arranged to take place along a collapsing path or direction D2, which collapsing path is preferably straight or at least substantially straight, and extends between the holder part 40 and the lens part 20. As a result, the device 1 as a whole is contracted as a consequence of the contraction of the distance part 30, whereby the outer dimensions of the device 1 decrease as a result of such collapse.

In other words, the device 1 as a whole is reversibly collapsible by means of the distance part being reversibly collapsible.

Such a device 1 can be made easily foldable or compressible to said contracted state, in which it is small when not in use, and thereby does not need much storage space. In fact, the exemplifying device 1 shown in the figures can fit in a normal pocket when not used and folded. At the same time, it can be easily expanded when to be used, in a way so that full viewing quality is assured by the said predetermined distance D1 being provided by the distance part 30.

In a particularly preferred embodiment, the distance part 30 forms a supporting structure of the device 1, supporting the holder part 40 in relation to the lens part 20. It is preferred that the distance part 30 is the only such supporting structure supporting the holder part 40 in relation to the lens part 20. In particular, it is preferred that the distance part 30, such as the bellows structure described below, is the only physical connection between the holder part 40 and the lens part 20.

Preferably, and as illustrated in the figures, the distance part 30 comprises a self-supporting structure, preferably such a structure made from flexible material such as rubber, silicone or TPE, which self-supporting structure is both the only supporting structure supporting the holder part 40 in relation to the lens part 20 and which when expanded provides the said predetermined distance D1 as a consequence of it being shape-stable in the fully expanded state. As will be seen in the following, it is in this case also preferably shape-stable in the fully compressed state. Such dual shape-stability can be accomplished by appropriate selection of the shape, an example being the bellows structure illustrated in the figures and comprising steps 34.

Hence, one preferred example of such supporting structure is an accordion-type bellows structure as shown in the figures, comprising at least one, preferably at least two foldable steps 34. In this case, the cross-section of the bellows structure comprises the said steps 34, and the bellows structure is arranged to collapse by one such step folding by bending in inside a neighbouring step, so that the bellows structure is compressed in the D1 direction or along the D1 path. This can be understood by comparing FIG. 1c (expanded bellows) to FIG. 3b (contracted bellows/folded steps).

Preferably, the steps 34 run circumferentially around the whole bellows structure. It is preferred that the flexible material of the bellows structure is of a thickness which varies in the D2 direction, in particular comprising thinner parts at the bending points of said steps 34. This provides a light-weight yet adequate bellows structure.

It is furthermore preferred that the bellows structure is generally tapered, so that it is broader at a first end 31 near the holder part and narrower at an opposite second end 32 near the lens part 20. Moreover, it is preferred that at least one narrower part of the bellows structure fits inside at least one broader part of the bellows structure when the bellows structure is collapsed, such as by one of said steps 34 folding into a wider step in a way as described above.

In general, the bellows structure comprises an envelope surface 33 which is made of the said flexible material, arranged to be compressed in the described way and which is preferably opaque. The light from the images 52, 53 of the screen display 51 will then travel through the interior of the bellows structure, as defined by the envelope surface 33, on its way to the lens part 20, and will not be disturbed by stray light from the outside of the envelope surface 33.

According to a preferred embodiment, the lens part 20 comprises a rigid part 21, such as a rigid frame, which is attached to the distance part 30 in an attachment plane perpendicular to the collapsing direction D2. Preferably, the rigid part 21 is fastened to the distance part 30, such as directly to the above discussed bellows structure, preferably at several attachment points along the periphery of the rigid part 21, which preferably surrounds the lenses 24, 25. Preferably, the fastening of the lens part 20 to the distance part 30 does not allow any stray light to enter into the device 1 and to the vicinity of the lenses 24, 25 via the joint between the lens part 20 and the distance part 30. In one example, the rigid part 21 may be glued to the bellows structure along the whole periphery near the bellows structure's second end 32.

The holder part 40 preferably also comprises a rigid part 41, attached to the distance part 30 in an attachment plane perpendicular to the collapsing direction D2, in a way similar to the attachment between the rigid part 21 and the distance part 30. When the electronic device 50 has been inserted into the holder part 40 and is accommodated therein, for instance by opening the lid 44, inserting the electronic device into the accommodation space 42 such that the device 50 rests against the rigid shoulder 43 and is held in position using one or several resilient foam parts (see below), the electronic device 50 is held in a fixed position in relation to the rigid part 41. This may, for instance, be achieved by the shoulder 43 being an integrated part of the rigid part 41.

In addition, the rigid part 21 of the lens part 20 is preferably fixed in relation to the lenses 24, 25. Hence, the predetermined distance D1 between the screen 51 and the lens part 20, in particular the lenses 24, 25, corresponds to a predetermined distance between the rigid part 41 and the rigid part 21.

Thus, it is preferred that the distance part 30 joins together the rigid part 21 to the rigid part 41, and is itself flexible but arranged to be more sturdy in the fully expanded state o the distance part 30. In other words, when the distance part 30 is fully expanded, the rigid parts 21, 41, and therefore also the lens part 20 and the holder part 40, have a relatively fixed geometric relationship. To the contrary, when the distance part 30 is partly or completely folded to its compressed state, the rigid parts 21, 41 may be more loosely related. One good and preferred way of achieving this effect is using a bellows structure of the above described type, but it would also be possible to use, for instance, a flexible membrane in combination with conventional helical metal springs as the distance part.

To the rigid frame 21, preferably on the side of the rigid frame 21 facing away from the distance part 30, is also fastened a face-abutting part 22, arranged to abut the face of the user 70 when the device 1 is in said mounted position. The face-abutting part 22 is preferably made of flexible material, and comprises a light shield 24 arranged to shut out any stray light from outside of the device to the user's 70 eyes when the device 1 is mounted. The light shield 24 further comprises a contact surface 23, arranged to abut against the face of the user 70. The face-abutting part 22 preferably resembles a scuba diving mask. When in use, the device 1 is supported on the user's 70 face by the flexible face-abutting part being pressed against the user's 70 face by the rigid part 21 of the lens part 20 being forced against the user's 70 head 71 by the strap means 12. Then, the holder part 40 is supported by the (flexible) distance part 30 which in turn is fastened to the rigid part 21.

When the device 1 is compressed for storage, the following takes place.

As the distance part 30 compresses, its steps 34 fold in, one into the next, so that the length of the distance part 30 in the D2 direction decreases. As a result, the distance part 30 is preferably collapsed so that it completely fits inside, and when completely compressed is arranged completely inside, the holder part 40. The lens part 20, being attached to the other end 32 of the distance part 30, preferably fits entirely inside the holder part 40, preferably inside the rigid part 41. This implies that that the lens part 20 has outer dimensions arranged to fit inside a cavity of the holder part 40, which cavity is comprised in the holder part 40 in addition to the accommodation space 42.

According to a preferred embodiment, the device 1 is generally shaped as a tapered cylinder, narrowing in a direction from the end 31 to the end 32, wherein the lens part 20 and the holder part 40 form respective end surfaces and the distance part 30 forms a tapered envelope surface running there between.

Furthermore, it is preferred that the accommodation space 42 for receiving and accommodating the electronic device 50 is arranged on a side of said rigid holder part 41 facing away from the distance part 30. The accommodation space 42 may, for instance, be accessed by sliding the electronic device 50 into the space 42 via an opening in the side of the holder part 40. However, it is preferred that a lid 44 is provided, opening to reveal and provide access to the accommodation space 42. The lid is preferably pivotally joined to the rigid part 41 of the holder part 40 using hinges 45.

Both the holder part 40 and the lens part 20 are preferably made from rigid plastic material.

According to one preferred embodiment, the fastening means 10 comprises one respective attachment point 11 for the flexible head strap 12 at each respective side of the device 1. Preferably, the attachment points 11 each comprise a respective flexible or pivotal part, such as in the form of fastening ears as shown in the figures, extending out from the lens part 20.

As is illustrated in the figures, the lens part 20 preferably further comprises a lens adjustment means 27, for instance provided as a wheel available from the outside of the device 1, such as arranged on the top side of the device 1, which is arranged to allow the user 70 to mechanically adjust the distance between the lenses 24, 25 comprised in the lens part 20 in order to correct for the different distance between the eyes of different users. No adjustment is necessary for the predetermined distance D1, since this is set to an optimal value as a result of the shape of the distance part 30 when fully expanded.

As is understood by the above, the device 1 itself, not comprising the electronic device 50 and not counting any remote control 60 (below), is preferably entirely mechanic, and does not comprise any electric or electronic circuitry.

It is furthermore preferred that the device 1 further comprises a remote control 60 (see FIGS. 3a-3c; 6), arranged to be wirelessly connected to the electronic device 50 and controlling the image viewed on said screen 51. Such wireless connection may be conventional as such, preferably using Bluetooth®, WiFi or similar wireless communication technology, and preferably using a piece of software application executed on or from the device 50 for interpreting commands from the remote control 60 and for taking appropriate action in reaction to such commands. Such general functionality of the remote control 60 in cooperation with the electronic device 60 is conventional as such, and is not described in detail herein. Examples of fields of use of the remote control 60 comprises switching between active applications on the device 50 when viewing submersive 3D images using the device 50; selecting items in 3D space; and controlling a virtual vehicle in a submersive 3D game played using the device 1 and the device 50.

The remote control 60 comprises controls 61 for interacting with the electronic device 50 in a way which is conventional as such, via said wireless interface.

It is preferred that the remote control 60 has a shape and dimensions so that it fits in the above described accommodation space 42.

This provides a way to be able to achieve a submersive 3D viewing device 1, comprising a wireless remote control 60, in a format which is portable enough to be able to bring it for instance in a pocket, and which is still robust enough to withstand handling when out and about, even for professional field use in heavy industry. When the device 1 is to be used, the remote control 60 is removed from the accommodation space 42, and the electronic device 50 is placed therein to fill its place.

Using the accommodation space 42 as a storage space for the remote control 60 when not occupied by the electronic device 50 is especially useful for a device 1 such as the one illustrated in the figures and discussed above, since the electronic device 50 needs to be fastened to a rigid structure 41 at the distal end 31 of the distance means 30 as viewed from the lens part 20, and since this rigid structure 41 will typically comprise holding/positioning means for fixing the position, in relation to the rigid structure 41, of the electronic device 50. In order to be able to use the device 1 with a variety of differently sized electronic devices 50, it is in general difficult to use the accommodation space 42 for accommodating a part of the compressed distance part 30 and/or lens part 20 when the device 1 is in its compressed state. The holding/positioning means should typically be arranged to predictably position the inserted device 50 in a location, along the extension plane of the screen 51, which in turn positions the images 52, 53 in a desired predetermined position in relation to the lens part 20. Therefore, the holding/positioning means are typically of a certain volume, making it difficult for the distance part 30 and lens part 20 to fit therein. Also, the shoulder 43, used to fix the screen 51 in a predetermined location, limits access to the accommodation space 42 from the side facing towards the distance part 30.

By the remote control 60 being sized and dimensioned as the electronic device 50, the remote control 60 can be held tightly in the accommodation space 42, without moving around.

In particular, it is noted that the device 1 comprising the remote control 60 is not arranged to provide a storage space for the electronic device 50 when not used, and is as such not intended for use as a protective device for the electronic device 50. Rather, it is a compact arrangement for providing a submersive 3D experience with a remote control, using an electronic device 50 which is provided as a separate entity.

According to a preferred embodiment, the accommodation space 42 is arranged with said holding/positioning means in the form of at least one resilient holding/positioning means, such as one or several blocks of resilient foam. Such holding/positioning means are arranged to adaptively hold an electronic device 50 the dimensions of which fall within a predetermined interval, such as the above stated interval. Preferably, the holding/positioning means are arranged to hold the device 50 in such a way so that the orientation and position of the screen 51 in the main extension plane of the screen 51 falls within a predetermined positioning tolerance.

How such resilient holding/positioning means are to be designed will fall within the ability of the skilled person to decide, depending on the type of electronic devices to be held in the accommodation space 42. One example is that the resilient holding/positioning means comprise at least one resilient foam part arranged to be compressed when the electronic device 50 is accommodated in the accommodation space 42, which compression depends upon the dimensions of the electronic device 50. For instance, a foam part may be arranged running along the inner periphery of the accommodation space, pressing the peripheric edges of the device 50 inwards. Another example is to use cooperating blade springs.

Regardless of the design of the holding/positioning means, the remote control 60 preferably has dimensions within the same dimension interval as is used for the electronic device 50.

When storing the device 1 between uses, it is hence compressed and folded together. This state is illustrated, for example, in FIG. 2b, but during storing the lid 44 should be completely closed and the strap 12 may be wound around the device 1. In this state, the outer dimensions of the device 1 are very compact, and all parts are protected from the environment by the holder part 40 and the strap 12. The remote control 60 is arranged inside the accommodation space 42, where it is safe and protected from the outside.

When the user 70 wishes to use the device 1 for submersive 3D image viewing, the strap 12 is unwound; the lid 44 is opened;

the remote control 60 is removed from the accommodation space 42 and paired with the electronic device 50 to use in a way which is conventional as such; the electronic device 50 is inserted into the space 42 via the open lid 44, which is then closed; the distance part 30 is expanded and the device 1 is put in the said mounted position on the user's 70 head 71.

When finished, the reverse steps are taken.

This handling is particularly easy when using a flexible-material distance part 30 according to the above, and in particular a bellows structure, is used. Namely, in order to expand such a distance part 30, it is sufficient to simply pull the lens part 20 and the holder part 40 apart from each other until the distance part 30 is fully expanded. In order to recompress the distance part, the user 70 simply presses the lens part 20 and the holder part 40 together.

Similarly, the flexible face-abutting part described above offers an easy way to simply press upon the contact surface 23 so that the part 22 is pressed towards the rigid part 21, and so that the face-abutting part 22 is compressed against the rigid part 21. Preferably, the face-abutting part 22 can be held in this compressed state using appropriately positioned flanges on the rigid part 21, by having a shape allowing the face-abutting part 22 (which is manufactured from flexible material such as silicone, TPE or rubber) to be reversed in a stable reversed/compressed position, or using a device 1 cover arranged to receive and accommodate the whole device 1.

This does not only provide a simple way of expanding and contracting the device 1, such expanding and contracting can also be performed in a fairly rough manner without risking breaking the device 1, since all or most movable parts are made from flexible material. This is important since a device 1 may be used by children.

In one aspect of the invention, the device 1 comprises the remote control 60. In another aspect, a kit is provided, which kit comprises the device 1 and the remote control 60.

Above, preferred embodiments have been described. However, it is apparent to the skilled person that many modifications may be made to the described embodiments without departing from the basic idea of the invention.

For instance, the device 1 may be fastened to the head 71 of the user 70 in other ways than using the strap 12.

In general, all the above described embodiments are provided as examples, and may be combined freely as applicable.

Hence, the present invention is not to be limited to the above described embodiments, but may be varied within the scope of the enclosed claims.

1-14. (canceled)

15. Device (1) for viewing stereoscopic 3D images using an electronic device (50) comprising a screen display (51), which device (1) comprises
a head fastening means (10), arranged to fasten the device (1) to a user's (70) head (71) so that the device (1) assumes a mounted position on said head (71);
a holder part (40) arranged to receive and removably accommodate the electronic device (50) in an accommodation space (42);
a lens part (20) arranged to focus light from said screen display (51) to the eyes of the user (70) when the device (1) is in said mounted position and the electronic device (50) is arranged in said accommodation space (42); as well as
a distance part (30), arranged to provide a predetermined distance (D1) between the lens part (20) and the screen display (51),
wherein the lens part (20) is arranged to, when the device (1) is in said mounted position, provide a first image (52a) from a first part (52) of the screen display (51) to a first eye of the user (70), and a second image (53a) from a second part (53) of the screen display (51) to a second eye of the user (70), which first (52) and second (53) parts are distinct from each other, wherein the holder part (40) is supported in relation to the lens part (20) by the distance part (30), the distance part (30) is arranged to be reversibly collapsible along a collapsing direction (D2), which collapsing direction (D2) extends between the holder part (40) and the lens part (20), from a fully expanded state, in which the lens part (20) is arranged at said predetermined distance (D1) from the screen display (51), to a contracted state, in which the lens part (20) is arranged closer to the holder part (40) than what is the case in said fully expanded state, and wherein the outer dimensions of the device (1) decrease as a result of such collapse.

16. Device (1) according to claim 15, wherein the distance part (30) forms the only supporting structure of the device (1) that supports the holder part (40) in relation to the lens part (20).

17. Device (1) according to claim 16, wherein the distance part (30) comprises a self-supporting accordion bellows structure.

18. Device (1) according to claim 17, wherein the bellows structure is made from a flexible material.

19. Device (1) according to claim 17, wherein the bellows structure is generally tapered, so that it is narrower at an end (32) near the lens part (20) and broader at an opposite end (31) near the holder part (40), and so that at least one narrower part of the bellow structure fits inside at least one broader part of the bellow structure when the bellow structure is collapsed.

20. Device (1) according to claim 17, wherein the bellows structure in cross-section comprises at least two steps (34), and wherein the bellows structure is arranged to collapse by one such step bending in inside a neighbouring step.

21. Device (1) according to claim 15, wherein the lens part (20) comprises a rigid part (21) attached to the distance part (30) in an attachment plane perpendicular to said collapsing direction (D2).

22. Device (1) according to claim 15, wherein the holder part (40) comprises a rigid part (41) attached to the distance part (30) in an attachment plane perpendicular to said collapsing direction (D2).

23. Device (1) according to claim 22, wherein the lens part (20) and the distance part (30) are arranged to completely fit inside the said rigid holder part (41) when the distance part (30) is collapsed.

24. Device (1) according to claim 22, wherein the said accommodation space (42) is arranged on a side of said rigid holder part (41) facing away from the distance part (30).

25. Device (1) according to claim 21, wherein the device (1) is generally shaped as a tapered cylinder, wherein the lens part (20) and the holder part (40) form respective end surfaces and the distance part (30) forms a tapered envelope surface.

26. Device (1) according to claim 15, wherein the lens part (20) comprises an adjustment means (27) for adjusting the distance between two lens means (24,25) comprised in the lens part (20).

27. Device (1) according to claim 15, wherein the device (1), apart from said electronic device (50) and not counting any remote control (60) for controlling the electronic device (50), is entirely mechanic, and does not comprise any electric or electronic circuitry.

28. Device (1) according to claim 15, wherein the device (1) further comprises a remote control (60), arranged to be wirelessly connected to the electronic device (50) and to control the electronic device (50), and wherein the remote control (60) has a shape and dimensions so that it fits in the said accommodation space (42).

29. The device of claim 18, wherein the flexible material is rubber, silicone, or TPE.
